(19) United States
(12) Patent Application Publication
(10) Pub. No.: US 2003/0064186 A1
(43) Pub. Date: Apr. 3, 2003

(54) Transparent container

(75) Inventors: Cezar Mourtada Anselmo, Vinhedo (BR); Mark Graham Branch, Bebington (GB); Luisa Franzone, Gaggiano (IT)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/231,421

(22) Filed: Aug. 29, 2002

(30) Foreign Application Priority Data
Sep. 6, 2001 (EP) 01307592.4

(51) Int. Cl. B32B 1/02

(52) U.S. Cl. 428/35.7

(57) ABSTRACT

A container for containing a consumer product wherein the container comprises a means for dispensing said product and a resilient wall, which wall comprises amorphous polyamide (APA), characterised in that the wall is substantially transparent or translucent.

### BACKGROUND OF THE INVENTION

1. The Field of the Invention

The present invention relates to a container comprising amorphous polyamide.

2. The Related Art

Amorphous polyamide (APA) is a material known in the art of packaging manufacture. It is known to have particularly suitable barrier properties enabling it to be used in the manufacture of packaging for consumer products.

Transparent or translucent containers are particularly attractive to the consumer since, unlike opaque containers, it is possible to see the actual product before purchase. It is also highly desirable to have coloured and/or flavoured products in cosmetic products to impart sensorial characteristics to the product. In fact, the flavour or colour of a product is often the most important factor when deciding to purchase one product or another.

Unfortunately, many flavours and colours degrade in the presence of U.V. light. Even in more temperate climes this often results in the product appearing less attractive to the consumer after it has been stored for some time in the presence of daylight. The flavours may even degrade to produce unattractive ingredients imparting an offensive taste to the product or colours can fade substantially. In an extreme scenario this may even cast doubt in the consumer's mind as to whether the product is genuine or a cheap copy.

The stability of the ingredients in the product may also be affected by the surrounding environment. For example, in a high humidity environment the barrier properties of some packaging materials change remarkably and this can result in a less attractive product should the products colour or flavour be affected.

Commonly used materials in packaging for products include the polyolefins, such as polypropylene and polyethylene, as well as polyvinyl chloride, polyacrylonitrile and ethylene vinyl alcohol (EVOH) amongst others.

The U.V. absorbance of prior art packaging may be improved with the inclusion of U.V. absorbing materials such as Tinuvin®, which is a form of titanium dioxide and is usually added to the EVOH layer to scatter light. Obviously, this cannot be added in high quantities otherwise the layer would become completely opaque and this is less attractive to the consumer who prefers to be able to see a product before purchase.

We have surprisingly found that APA provides sufficiently improved barrier properties against U.V. that it is now possible to store a product comprising a barely stable colour or flavour in a substantially transparent or translucent container without having to worry about the problems identified with the prior art as described below.

### SUMMARY OF INVENTION

Accordingly, the present invention provides a container for containing a consumer product wherein the container comprises a means for dispensing said product and a resilient wall, which wall comprises amorphous polyamide (APA), characterised in that the wall is substantially transparent or translucent.

The term substantially transparent or translucent as used herein means not opaque and that light can pass through a wall of the material which is of substantially similar thickness to that used in a tube for toothpaste. This thus means that the wall may be visually clear or even just translucent. Accordingly, a person would be able to see a coloured product contained in the container according to the invention.

The wall preferably comprises from 40 to 100% amorphous polyamide (APA) by which is meant any of the partially aromatic polyamides which are commonly referred to as APA in the art. Typical APAs are commercially available from EMS-Chemie as Grivory®. Suitable grades of Grivory® include Grivory G21®. Other brands of APA include Selar PA® from Du Pont and particularly suitable grades include 3426 and 2072.

Preferred APAs have an O₂ permeability of from 5 and 50 cm³/m².d.bar at 23° C. and 0% relative humidity. More preferably this O₂ permeability is from 20 and 40 and most preferably from 25 to 35 cm³/m².d.bar at 23° C. and 0% relative humidity.

Further, more preferred APAs have an O₂ permeability of from 3 and 15 cm³/m².d.bar at 23° C. and 85% relative humidity. More preferably this O₂ permeability is from 5 and 12 and most preferably from 7 to 9 cm³/m².d.bar at 23° C. and 85% relative humidity.

Preferably, the wall of the container comprises a laminate structure. Laminate structures are common in the packaging materials art and an example can be found disclosed in WO 98/42506 (Courtaulds). This PCT application discloses a laminate material comprising an impermeable core layer, e.g. EVOH, sandwiched between materials such as linear low density polyethylene (LLDPE) or polyethylene (PE). The entire laminate may measure from 200 to 350 μm in thickness with the core layer comprising approximately 10 to 30 μm of that. The core layer may also be fixed to each of the other layers by an adhesive such as PE-type adhesive which itself may comprise approximately 5 to 25 μm. Any one of the layers may also comprise materials to influence the visual characteristics of the laminate. For example, should U.V. absorbers be required they will be present in the layer of the product, which is outermost from the contained product. Should titanium dioxide be present to opacify the container slightly, it will usually be present in the layer which is in contact with the contained product.

Where the wall according to the invention is a laminate it preferably comprises at least one layer which comprises from 0.1 to 100% APA, more preferably from 50 to 100% and especially from 90 to 100% APA. Where the APA layer comprises less than 100% APA the remainder will comprise another thermoplastic material common in the art. For example, nylon 6, 66, EVOH or other polyolefinic materials may comprise the rest of the layer. Preferably, the APA layer will constitute the core layer in a typical laminate structure, which will, of course, comprise a similar overall laminate structure to that disclosed in WO 98/42506 described below with sandwiching polyolefin layers.

The laminate may also comprise a core layer which is located anywhere within the laminate providing that it is sandwiched to at least some extent by the more usual layers as described below. According to a preferred embodiment the wall material comprises less than 0.1%, more preferably no titanium dioxide. This is because the U.V. absorption properties of the APA are sufficient to prevent U.V. radiation from degrading typically used flavours and colours in the contained product.

In an alternative aspect the invention relates to a container according to claim 1 wherein the consumer product to be contained is any selected from oral compositions, shower gels, cleaning compositions such as bleaches etc, deodorants, antiperspirants, polishes, waxes, adhesives, or any generally flowable product which may benefit from the advantages of a transparent container in the form of a tube and which has colour or flavour as an attractive feature for the consumer. Preferably, the product to be contained is an oral composition, for example a dentifrice or a mouthwash. preferably, this oral composition comprises from 0.001 to 10% by weight of a flavour or a colouring pigment.

The colourants used to prepare the product, where the product is an oral composition are pharmacologically and physiologically non-toxic when used in the suggested amounts. The colourants include both pigments an dyes. Pigments useful in the practice of the present invention include non-toxic, water insoluble inorganic pigments such as titanium dioxide and chromium oxide greens, ultramarine blues and pinks and ferric oxides as well as water insoluble dye lakes prepared by extending calcium or aluminum salts of FD&C dyes on alumina such as FD&C Green #1 lake, FD&C Blue #2 lake, FD&C R&D #30 lake and FD&C # Yellow 15 lake. The pigments have a particle size in the range of 5-1000 microns, preferably 250-500 microns.

Dyes used in the practice of the product according to this second aspect of the present invention are distributed uniformly throughout the oral composition and are desirably food colour additives presently certified under the Food Drug & Cosmetic Act for use in food and ingested drugs, including dyes such as FD&C Red No. 3 (sodium salt of tetraiodo fluorescein), Food Red 17, disodium salt of 6-hydroxy-5-{(2-methoxy-5-methyl-4-sulphophenyl)azo)-2-naphthalenesulfonic acid, Food Yellow 13, sodium salt of a mixture of the mono and disulphonic acids of quinophtalone or 2-(2-quinolyl)indanedione, FD&C Yellow No. 5 (sodium salt of 4-p-sulphophenylazo-1-p-sulfophenyl-5-hydroxypyrazole-3 carboxylic acid), FD&C Yellow No. 6 (sodium salt of p-sulfophenylazo-B-naphtol-6 monosulfonate), FD&C Green No. 3 (disodium salt of 4-{[4-(N-ethyl-p-sulphobenzylamino)-phenyl]-(4-hydroxy-2-sulfoniumphenyl)-methylenel-[1-(N-ethyl-N-p sulphobenzyl)-˜E-3,5-cyclohexadienimine], FD&C Blue No. I (disodium salt of dibenzyldiethyl-diaminotriphenylcarbinoI trisulphonic acid anhydrite), FD&C Blue No. 2 (sodium salt of disulphonic acid of indigotin) and mixtures thereof in various proportions.

The concentration of the dye for the most effective result in the present invention is present in the oral composition in an amount from about 0.05 percent to about 10 percent by weight with respect to the weight of the total composition and preferably present from about 0.1 percent to about 5 percent of the total weight of the composition.

In a preferred embodiment the container according to the invention is packaged in another outer container such as a box or carton, etc. Since the attractive feature for the consumer may be the colour it is beneficial for the box to also comprise a window in its structure to allow the consumer to see the product inside the container while it is contained within the carton.

The foregoing description and examples illustrate selected embodiments of the present invention. In light thereof variations and modifications will be suggested to one skilled in the art, all of which are within the spirit and purview of this invention.

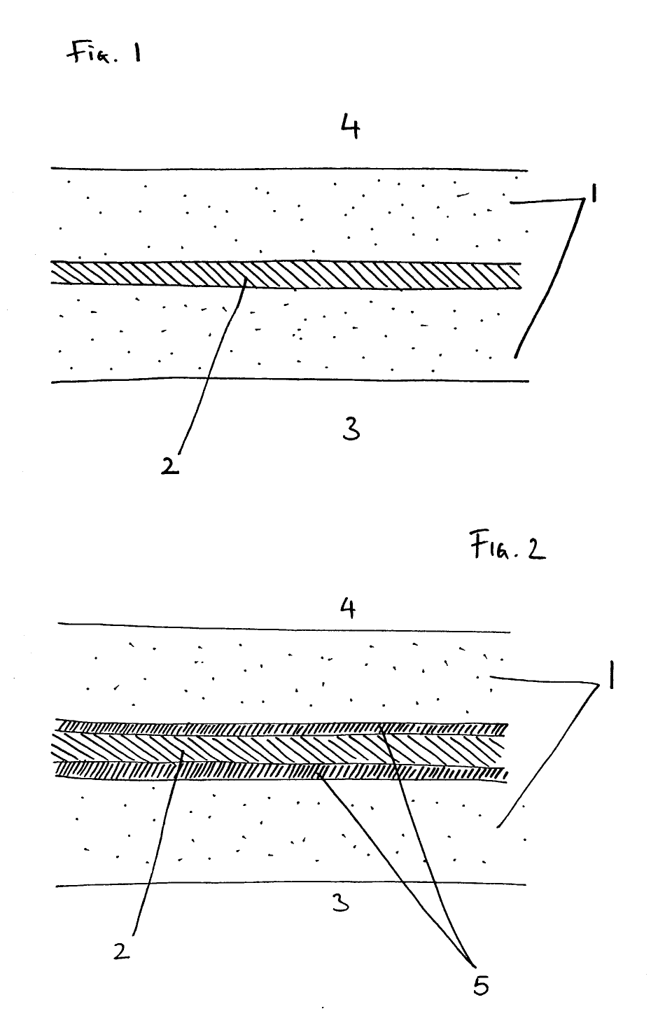

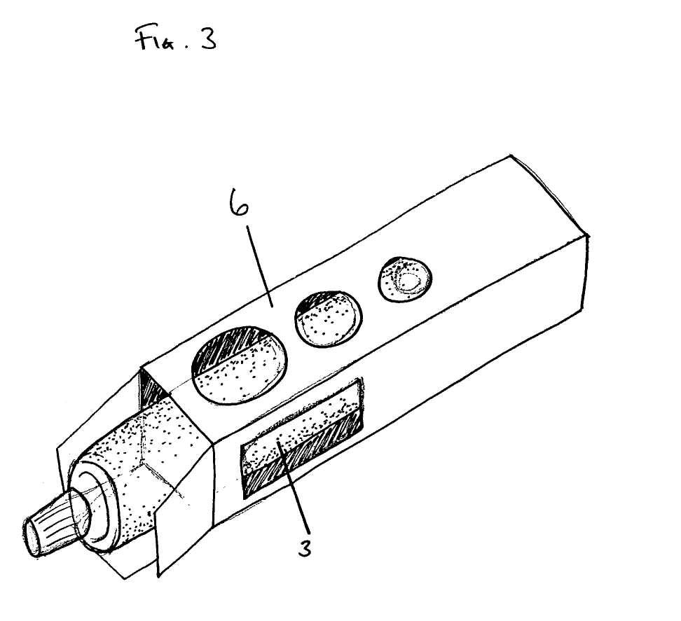

Embodiments according to the invention shall now be described with reference to the following non-limiting figures in which FIGS. 1 and 2 disclose sections through a container wall according to the invention.

FIG. 1 discloses a pair of laminate constituents (1) which would typically comprise polyolefinic materials and which sandwich a core layer (2) which would typically comprise APA. The laminate constituent (1) outermost from the product (3) contained within the container is the layer which would typically comprise any materials which would affect the visual characteristics of the wall. As discussed below it is perfectly feasible for this core layer (2) to be present at any level within the wall material as a whole, i.e. it can be closer to either of the edges of the wall rather than situated in the middle.

FIG. 2 discloses a pair of laminate constituents (1), a core layer comprising APA (2) and which is adhered to the laminate constituents (1) by way of adhesive layers (5).

FIG. 3 discloses a container according to the invention which is stored in a carton (6) which itself comprises a window (7) to allow the consumer to visualise the product (3).

What is claimed is:

1. A container for containing a consumer product wherein the container comprises a means for dispensing said product and a resilient wall, which wall comprises amorphous polyamide (APA), characterised in that the wall is substantially transparent or translucent.

2. A container according to claim 1, wherein the wall comprises a laminate structure.

3. A container according to claim 1, wherein the wall comprises less than 0.1% by weight titanium dioxide.

4. A container according to claim 1, wherein the APA has an O₂ permeability of between 5 and 50 cm³/m².d.bar at 23° C. and 0% relative humidity.

5. A container according to claim 1, wherein the APA has an O₂ permeability of between 3 and 15 cm³/m².d.bar at 23° C. and 85% relative humidity.

6. A container according to claim 1, wherein the container is a container for an oral composition.

7. A packaged product comprising a carton for containing a container according to any of claims 1-6 and containing a consumer product, wherein the carton comprises a window in its structure to allow visualisation of the consumer product within the container.
